(19) United States
(12) Patent Application Publication
(10) Pub. No.: US 2019/0080621 A1
(43) Pub. Date: Mar. 14, 2019

(54) SWARM CONSISTING OF A PLURALITY OF LIGHTWEIGHT DRONES

(71) Applicant: THALES, Courbevoie (FR)

(72) Inventors: Gilles GUERRINI, Pessac Cedex (FR); Patrick GARREC, Pessac Cedex (FR); Ema FALOMIR, Bordeaux (FR)

(21) Appl. No.: 16/125,658

(22) Filed: Sep. 7, 2018

(30) Foreign Application Priority Data
Sep. 8, 2017 (FR) 17 00905

(51) Int. Cl. G08G 5/04; G05D 1/10; B64C 39/02

(52) U.S. Cl. CPC G08G 5/04; B64C 2201/143; B64C 39/024; G05D 1/104

(57) ABSTRACT

This swarm (101) is made up of a plurality of drones (111-115), the drones being flying drones, the drones forming a communication network with one another. It is characterized in that the swarm implements, autonomously, an obstacle avoidance functionality (20) based on a collaborative observation of the environment of the swarm by each of the drones and the sharing of obstacle detection information among the drones.

### CROSS-REFERENCE TO RELATED APPLICATIONS

This application claims priority of French Patent Application No. 17 00905, filed on Sep. 8, 2017.

### FIELD OF THE INVENTION

The invention relates to the field of swarms of flying drones. It more particularly relates to the detection and obstacle avoidance functions for such drones.

### BACKGROUND OF THE INVENTION

One of the primary interests of a swarm of drones lies in the fact that it may be considered, by the operator remotely controlling it, a unique entity.

In order for this to be possible, some functionalities must be managed by the swarm itself, without intervention by the operator.

These functionalities managed autonomously by the swarm in particular include the functionality of determining individual trajectories of each of the drones.

This functionality must make it possible to perform the mission assigned to the swarm, for example moving toward a predefined destination point, taking account of the relief of the overflown terrain; the weather; the presence of stationary or moving obstacles in order to avoid them; the presence of other drones in the swarm to avoid collisions within the swarm; and optionally the malfunction of one or several drones in the swarm.

The functionality of determining individual trajectories is in particular based on an obstacle detection functionality in order to avoid them.

Currently, obstacle detection is carried out by a primary drone, called “detector” drone, which has an onboard sensor system allowing a complete observation of the environment of the swarm. “Complete” refers to the ability of the sensor system to observe at least one zone of +/−110° in azimuth and +/−10° in elevation, over a depth of several hundred meters. This corresponds to what is asked of the pilot of a fixed-wing airplane in terms of field of view.

For example, the sensor system comprises a radar for the long-distance detection of obstacles and an optical camera for the identification of the obstacles detected by the radar.

This effective solution, however, involves having an elaborate, and therefore costly, sensor system on board the platform making up the drone.

Such a sensor system also having a substantial weight, it is necessary to size the “detector” drone so that it can take on such a load. It is therefore not a mini-drone, or light drone, i.e., a small drone of the four-engine type, like those that may be found on the market for the general public.

In any case, it is different from the other drones in the swarm.

If this “detector” drone is destroyed or breaks down during the mission, the swarm is no longer able to detect and therefore avoid the obstacles. The performance of the mission is then completely compromised.

Furthermore, it is not possible to consider equipping each of the drones in the swarm with such a sensor system, since it would be necessary to size each of the drones so that it can take on such a load. As a result, this solution can only be considered for powerful drones, which would therefore not be light drones. This solution would be very costly in terms of platform and sensor system.

Other solutions can be considered, such as detecting obstacles from the ground, then communicating detection information from the ground detection station to the drones.

However, this solution involves communications between the ground and the swarm during the performance of the mission. Such communications lack discretion.

Furthermore, the observation of the environment of the swarm from the ground is not good for grazing angles, such that obstacle detection on the ground (bridge, pylons, etc.) is of poor quality.

Lastly, if obstacle detection is done in this way, one is no longer in the context of a function managed autonomously by the swarm.

Another solution consists of making a map of the region where the mission takes place, in particular mentioning the obstacles to be avoided. This map is stored in the memory of the drones and is taken into account when carrying out the mission. Here again, the detection is not done autonomously by the swarm.

But above all, such a solution does not make it possible to detect moving obstacles in the mapped region.

Lastly, the swarm cannot venture outside the region corresponding to the stored map.

### SUMMARY OF THE DESCRIPTION

The invention therefore aims to propose an alternative to the preceding solutions, in particular a solution that can be implemented autonomously by the swarm.

To that end, the invention relates to a swarm made up of a plurality of drones, the drones being flying drones, the drones forming a communication network with one another, characterized in that the swarm implements, autonomously, an obstacle avoidance functionality based on a collaborative observation of the environment of the swarm by each of the drones and the sharing of obstacle detection information among the drones.

According to particular embodiments, the swarm comprises one or more of the following features, considered alone or according to any technically possible combinations:
each drone has: a sensor system allowing the observation of the environment of the swarm within a partial observation envelope and the generation of obstacle detection information in case of the presence of an obstacle within said partial observation envelope; a radio communication means for establishing at least one communication link with another drone of the swarm to exchange obstacle detection information; and a computing unit capable of computing an individual trajectory of the drone from obstacle detection information generated by said drone or received from another drone in the swarm.
the computing unit of each drone is able to determine a relative position and/or a relative speed of at least one drone close to said drone, the computing unit of said drone computing the individual trajectory of said drone while further taking into account said relative position and/or said relative speed.
the computing unit of each drone computes the individual trajectory of said drone such that the swarm adopts an optimized configuration.
the configuration is optimized by maximizing a zone of the environment observed by the swarm, the observed zone corresponding to the union of the partial observation envelopes of each drone of the swarm.
the swarm moving along a main direction, the drones are oriented so that the observed zone is preferably located in front of the swarm of drones.
the configuration is optimized such that a topology of the communication network formed among the drones of the swarm is connected, preferably bi-connected.
the swarm is able to move away from its optimized configuration by deformation to avoid an obstacle, then to resume the initial optimized configuration after having passed the obstacle.
the configuration is optimized such that a distance between two close drones is constrained around a reference distance.
the drones are identical to one another, the sensor systems taken on board by each of the drones being identical.
the drones are different, the sensor systems taken on board by each of the drones being identical or different, the swarm being heterogeneous.
each drone is a light drone, having a total span of less than a meter.
the computing unit of the drones stores a matrix meshing the environment of the swarm, the matrix being subdivided into cells, each cell in which an obstacle has been detected being associated with a flag, an update of the matrix being done from obstacle detection information generated by said drone or received from another drone of the swarm.
the dimensions of the cells of the matrix depend on the partial observation envelopes of the sensor systems of the drones of the swarm.

The invention also relates to a detection and obstacle avoidance method carried out in a swarm according to the preceding swarm, characterized in that it comprises the steps consisting of: adoption of an optimized configuration by the swarm; observation of a zone of the environment corresponding to the union of the partial observation envelopes of each drone of the swarm; sharing of the obstacle detection information generated by a drone with the other drones of the swarm using the communication network established among the drones of the swarm; and calculation by each drone of its individual trajectory, taking account of the obstacle detection information that it has generated and/or that it has received from other drones.

According to specific embodiments, the method includes one or more of the following features, considered alone or according to any technically possible combinations:

### BRIEF DESCRIPTION OF THE DRAWINGS

The invention and its advantages will be better understood upon reading the following detailed description of one particular embodiment, provided solely as a non-limiting example, this description being done in reference to the appended drawings, in which:

FIG. 1 is a schematic illustration of a swarm of seven drones adopting an optimal configuration for obstacle detection and avoidance;

FIGS. 2 to 5 show a swarm of five drones in different successive configurations during the avoidance of a detected obstacle; and

FIG. 6 is a schematic illustration of a map of the environment advantageously used by each of the drones in the swarm.

### DETAILED DESCRIPTION

### General Principle

According to the invention, each drone in the swarm has an inexpensive on-board sensor system with a reduced weight, but which only makes it possible to observe a limited fraction of the environment of the swarm. The geometry of this partial observation envelope depends on the angular coverage of the selected on-board sensor(s).

While each drone may only provide an observation of the environment inside a reduced observation envelope, the drones share the obstacle detection information that they produce by exchanging this information with one another over the communication network that they establish with one another.

Each drone may then develop a depiction of the environment indicating the obstacles to be avoided. The obstacle detection functionality is therefore distributed among the various drones.

Based on this depiction, each drone determines its individual trajectory in real-time so as to avoid collisions with the detected obstacles.

The calculation of the individual trajectory accounts for other information, such as the relative position and/or the relative speed of the other drones in the swarm so as to avoid collisions with the other drones in the swarm.

The swarm adopts a configuration making it possible to optimize the zone covered by the individual observation envelopes, while optimizing the inter-drone communication network (each drone representing a node of the network and each communication link between two drones constituting a link between two nodes of the network).

In particular, the observation zone is optimized by suitably orienting the observation direction of the sensor systems of the drones relative to a movement direction of the entire swarm.

The network is optimized by securing the number of communication links established between the drones of the swarm.

While the swarm has adopted a particular configuration, the avoidance of an obstacle is reflected by a deformation of the swarm, which returns to its initial configuration once the obstacle is passed.

This solution makes it possible to miniaturize the on-board sensor system of each drone, reduce the weight thereof, and therefore allow the use of smaller platforms.

This solution also allows greater reactivity of the swarm, since the small drones have an extremely reduced inertia and therefore a reactivity of less than a second.

In this scheme, the loss of one drone from the swarm results in the real-time reconfiguration of the swarm made up of the remaining drones. The detection and obstacle avoidance function may still be performed, and the mission that the swarm must perform may still be carried out.

### Structure

A swarm of drones is made up of a plurality of N drones.

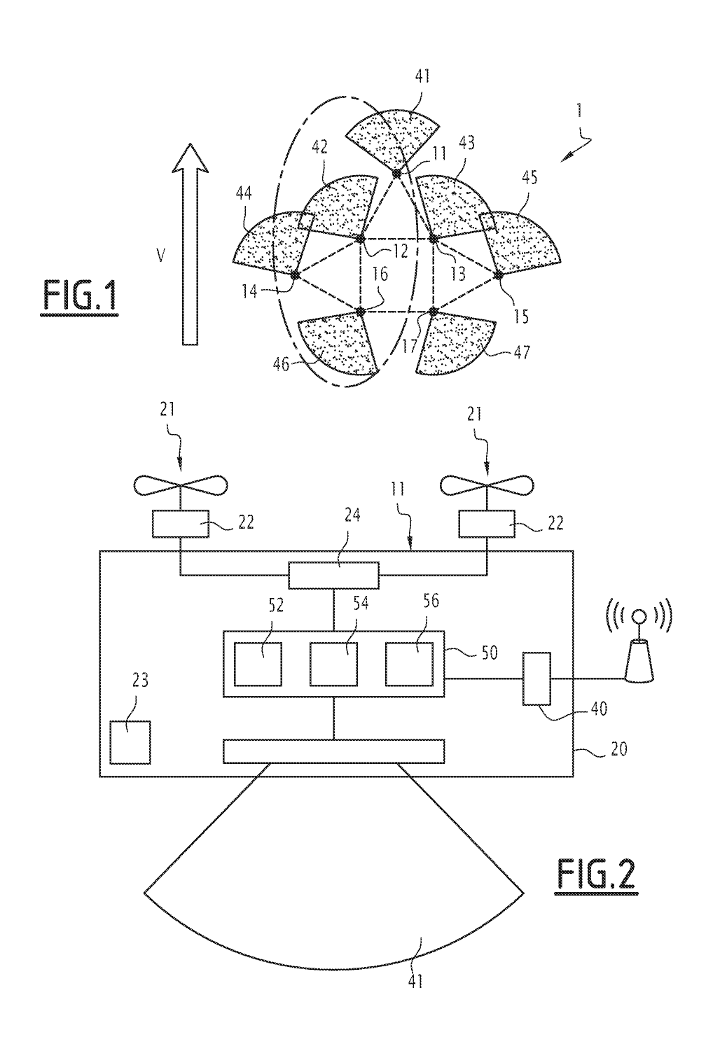

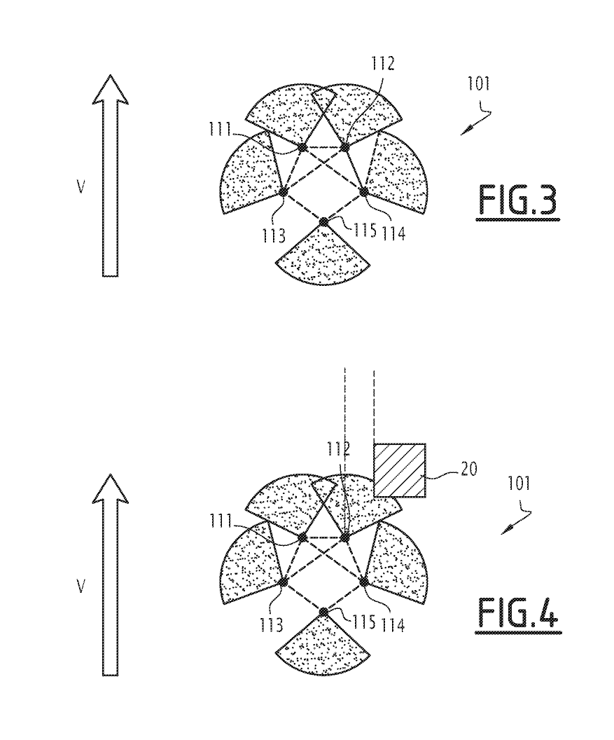

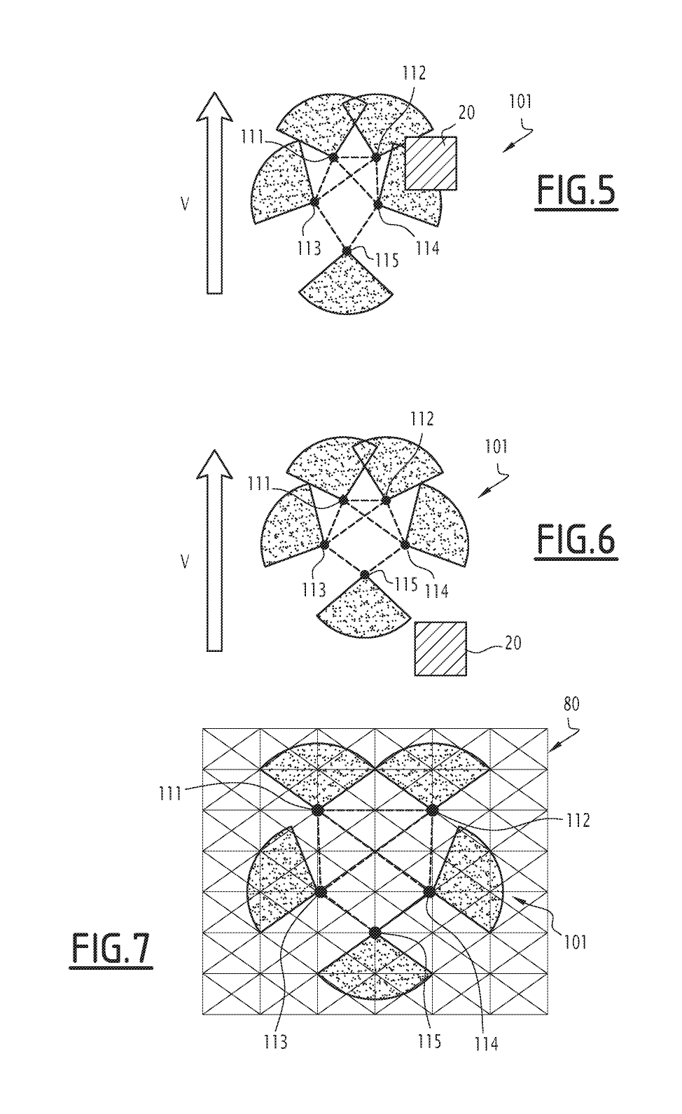

In FIG. 1, the swarm 1 is made up of seven drones 11 to 17, while in FIGS. 2 to 6, the swarm 101 is made up of five drones 111 to 115.

As illustrated by FIG. 2, a drone, such as the drone 11, is a flying platform, for example a multirotor, like those that are commercially available to the general public.

It is small. For example, it has a total span of less than a meter.

It for example comprises four rotors 21 rotated by motors 22, powered by suitable power supply means 23 controlled by suitable actuating means 24.

Such a drone may for example fly at a maximum speed of 50 km/h.

It has a reduced inertia, giving it very significant maneuverability.

A drone 11 comprises a system of sensors 30. This involves one or several sensors allowing an observation of the environment over a partial observation envelope. The observation envelopes of the drones 11 to 17 are referenced 41 to 47.

The observation envelope for example has a 90° opening in azimuth and +/−10° in elevation and a limited range, but sized in particular based on the maximum speed of the drone used.

The range is for example dimensioned as follows. The drones having a maximum speed of about 50 km/h, the detection distance must make it possible to avoid a frontal collision between two swarms moving toward one another, each at 14 m/s, or at 28 m/s on approach. The inertia being negligible, a detection at a distance of 50 meters is sufficient as long as the communication times between the drones of a swarm are minimal. It will therefore be necessary to adapt the topology of the communication network formed by the swarm based on this constraint.

A system of sensors 30 made up of an inexpensive optical camera satisfies this sizing of the detection range.

Preferably, the camera also works in the infrared domain, so as to be able to confirm the detections in the optical domain from a heat signature of the detected obstacle.

Advantageously, the system of sensors 30 incorporates a sound (or sonar) sensor allowing the camera to be made redundant at a lower cost and smaller bulk.

Alternatively, other types of sensors could be used, such as a radar sensor, a lidar sensor, or any combination of the types of sensors set out above.

In the considered embodiment, the various drones 11 to 17 of the swarm 1 are identical, when they are considered independently of the system of sensors that they have on board. If the sensor systems of the drones are identical to one another, the drones are said to be identical. If the sensor systems of the drones are different, the drones are said to be similar.

Alternatively, the various drones of the swarm are different, when they are considered independently of the system of sensors that they have on board. Reference is then made to different drones that have identical or different sensor systems on board. The swarm is then said to be heterogeneous.

The drone 11 comprises a radio communication module 40 allowing the establishment of communication links with other drones of the swarm. The drones with which a drone has, at the current moment, established a communication link are called “neighboring” drones of the drone in question. In FIG. 1, the established links are shown by dotted lines. For example, the drone 12 has the drones 11, 13, 14 and 16 as neighboring drones.

Advantageously, the communication between two drones is done by wideband or ultra-wideband, which has the advantage of allowing an easy determination of the distance between the two drones in communication, as is known by one skilled in the art.

A drone may for example establish a maximum of three links. Indeed, beyond this maximum number of links, the bandwidth risks being insufficient.

The drone 11 also has an on-board computing unit 50 comprising a processor and memory. The processor is able to execute the computer program instructions stored in the memory.

In particular, the computing unit 50 executes an obstacle detection program 52.

This program makes it possible, when it is executed on a drone, for example the drone 11, to acquire and process signals delivered by the sensor(s) of the sensor system 30 of the drone 11, to generate obstacle detection information.

It also allows the exchange of detection information with the other drones. The drone 11 thus emits detection information that it has produced and receives, from its neighbors, detection information produced by other drones of the swarm.

It lastly allows the update of a matrix stored in the memory of the drone 11, such as the matrix 80 shown in FIG. 7.

This matrix is a depiction of the environment of the swarm.

The matrix is made up of a plurality of cells paving the environment of the swarm.

FIG. 7 schematically shows such a matrix subdividing the space surrounding the swarm into a plurality of cells.

Two solutions can be considered: the matrix is relative to the swarm and it is for example determined in a coordinate system associated with a particular drone, called primary drone, or the barycenter of the drones of the swarm; or the matrix is predefined relative to the terrain, i.e., stationary relative to the ground, which is of interest when a digital terrain model is used.

The cells of the matrix are advantageously adapted to the dimensions of the observation envelopes of the sensor systems of the drones.

A flag is associated with a cell when an obstacle is detected in said cell. Advantageously, this flag indicates the detection moment of the obstacle and is only kept for a suitable remanence duration.

The computing unit 50 also executes a program 54 for determining the instantaneous configuration of the swarm.

It is preferable for each drone to know the general configuration of the swarm at each moment. However, to do this, the quantity of information to be exchanged over the network in order for each of the drones to be able to keep this knowledge is too great, is not always useful, and risks penalizing the exchange of obstacle detection information considered to have priority.

It is therefore considered to limit the knowledge that a drone in the configuration of the swarm has of the position of geographically close drones, so as to limit the information to be sent over the communication network. Close drones refer to the set of drones located within a volume centered on the drone in question and having an extension along the direction of the speed V of movement of the swarm that depends on the amplitude of said speed. For example, if when stopped, this volume is a sphere with radius R, during the movement of the swarm, this volume deforms in an ovoid with small axis R in the direction perpendicular to the speed V and large axis R(1+V/V0), where V0 is a reference speed, in the direction of the speed V. Such a volume is shown by a in FIG. 1 for the drone 12. The drones geometrically close to the drone 12 are the drones 11, 14 and 16.

The determination of the relative position between two drones that are both close and neighboring is done for example from the measurement of the distance between two drones having established a UWB radio communication link, as indicated above, optionally coupled with an angle measurement between the two drones using an on-board goniometry system.

The determination of the relative position between two drones that are close but are not neighboring goes through the determination of relative positions with respect to an intermediate drone and the exchange of these measurements over the network.

The computing unit 50 executes a program 56 for computing the individual trajectory of the drone 11. The computed trajectory is used by the means 24 for the suitable actuation of the motors and the movement of the drone, in particular to avoid an obstacle or a collision with another drone.

Over a communication link, a drone is ultimately able to exchange messages with its neighbors comprising the following information:
an identifier of the drone sending the message;
the instantaneous position and the instantaneous speed of the sending drone;
the identifiers of neighboring drones of the sending drone;
relative position information between the sending drone and close drones, for example the distance between said drones and the angle between said drones; and
obstacle detection information generated by the sending drone or received by the sending drone from a neighboring drone.

This obstacle detection information for example assumes the form of a list indicating the coordinates of the cells of the matrix in which an obstacle has been detected and the associated flag.

A drone may receive the same detection information from several of its neighbors. These redundancies advantageously allow the implementation of an integrity check.

### Operation

The operation of the swarm will now be described in reference to FIGS. 3 to 6.

Each drone 111 to 115 of the swarm 101 moves along a main direction (corresponding to the direction of the speed V of the swarm), toward a common objective, defined in the mission assigned to the swarm and stored by each of the drones. This objective for example consists of a geographical destination point.

For its movement, the swarm 101 dynamically adopts a configuration that results from the optimization of a cost function making it possible to take account of different constraints, in particular a first optimized observation constraint of the environment and a second optimization constraint of the topology of the communication network within the swarm.

The first constraint forces the swarm to adopt a configuration allowing an observation of the environment with optimal coverage. In particular, the different partial observation envelopes of the sensor systems of the drones are oriented based on one another and on the main movement direction of the swarm to maximize the likelihood of detecting moving or stationary obstacles with which one or another of the drones of the swarm risk colliding.

Each drone is thus dynamically assigned to an observation task consisting of observing a sector of the environment, in particular certain cells of the matrix when such a map is used. The observation task depends on the position of the considered drone in the adopted configuration.

The sectors of the environment located in front of the swarm, i.e., toward which the swarm is moving, are monitored as a priority.

Thus, the detection envelopes of the drones 111 and 112 arranged on the front side of the configuration adopted by the swarm 101 are oriented toward the front and are adjacent or are slightly superimposed at their borders so as to perform continuous spatial monitoring of the sector located in front of the swarm.

Advantageously, the drones 113 and 114 located on a lateral side of the configuration move such that their observation direction and their movement direction forms an angle suitable for the observation of a sector located on the side of the swarm.

Advantageously, the drone 115 located on a rear side of the configuration moves such that its observation direction and its movement direction forms an angle suitable for the observation of a sector located behind the swarm, so as to be capable of detecting moving obstacles approaching the swarm from behind.

The second constraint forces the swarm to adopt a configuration optimizing the topology of the network. Advantageously, the topology of the network is connected, i.e., each drone can exchange messages with all of the other drones of the swarm either directly (i.e., with a neighboring drone, like the drone 112 with the drones 111, 113 and 114) or indirectly by means of drone(s) serving as relay nodes (like the drone 112 with the drone 115 via the drone 114).

Advantageously, the topology of the network is bi-connected, such that if any drone is removed, the swarm remains connected.

The second constraint on the topology of the network also implies that a distance between two drones is maintained around a reference distance D0 during the movement of the swarm and the obstacle avoidance.

This reference distance D0 is for example considered to be the minimum between the maximum range of the communication means between two drones (for example, 300 meters in the case of an ultra-wideband UWB system) and two times the range of the sensor system. In this way, when an obstacle is detected by a drone, the latter is able to send an appropriate message to the other drones of the swarm, and the drones have time to modify their trajectories to avoid the detected obstacle as well as any collision within the swarm.

Furthermore, this reference distance D0 makes it possible to anticipate a loss of the communication between two drones, when the distance between two communicating drones increases beyond the value D0.

An example optimized configuration is shown in FIG. 3 with a swarm 101 made up of five drones adopting a substantially regular pentagon configuration.

During the movement of the swarm 101, each drone acquires signals delivered by its sensor system and processes them so as to detect the presence of an obstacle in its observation envelope and determine the position of the obstacle.

The position of an obstacle is for example given by the coordinates of the cell of the matrix within which this obstacle has been detected.

Once a drone detects an obstacle, it shares this detection information with its neighbors, by sending an appropriate message.

When a message is received comprising obstacle detection information generated by a neighbor, a receiving drone sends its neighbors a message reiterating this detection information. Thus, the initial detection information is shared among all of the drones of the swarm.

Once a drone receives a message comprising obstacle detection information, it updates its stored matrix. The detection information is dated and has an expiration date based on the renewal rate, the time, and the speed of the swarm.

At each moment, a drone computes its trajectory. For example, this computation consists of determining the direction of the instantaneous speed and the amplitude of the instantaneous speed of the drone.

This computation takes into account:
the distance between the drone in question and its neighboring drones;
the relative speed between the drone in question and its close drones;
the relative direction between the drone in question and its close drones;
the presence or absence of obstacles in the cells of the matrix toward which it is moving; and
the presence or absence of obstacles near its close drones.

By taking these different variables into account, the drone in question maintains a distance between itself and its neighbors, which varies around the reference distance D0 so as to maintain the communication link.

Thus, in FIG. 3, the swarm 101 moves along a main direction by adopting a regular pentagon formation, each drone constituting an apex of said pentagon.

Each drone moves substantially parallel to the main direction.

The drones on the front side monitor the environment in front of the swarm. The lateral drones monitor the environment on the side of the swarm. The rear drone monitors the environment behind the swarm.

In FIG. 3, an obstacle 20 is detected by the front right drone 112.

The drone 112 sends the obstacle detection information to its neighbors 111, 113 and 114.

The latter in turn pass this obstacle detection information on to the drone 115.

Each drone immediately updates its matrix depicting the environment.

In parallel, each drone determines the relative position and speed of the close drones. For example, the drone 114 computes the relative position and speed of the drones 112 and 115, or the drone 115 computes the relative position and speed of the drones 112 and 114.

Each drone computes its individual trajectory by taking into account the obstacle detection information, in particular the information carried by the matrix stored in the memory of the computer 50 when such a matrix is used, and the position and/or speed of the close drones.

In particular, the drone 114, informed of the presence of the obstacle 20 detected by the drone 112, modifies its individual trajectory so as to bypass said obstacle. It moves toward the left in FIG. 5 and thus approaches the barycenter of the swarm.

The drone 115, observing the approach of the drone 114, slows down so as to offset itself more toward the rear of the swarm in FIG. 5.

The initial pentagonal configuration is deformed dynamically so as to allow the swarm to bypass the obstacle 20.

Lastly, in FIG. 5, the swarm 101 having bypassed the obstacle 20, it returns to its initial configuration in a regular pentagon. The matrix of each drone is updated by resetting the cell(s) where the presence of the obstacle 20 had been signaled.

### Alternative Embodiments

Many alternatives can be considered. For example, for the case of a swarm including a large number of drones, a priority process is advantageously implemented in sending messages between drones. A drone analyzing the environment in the direction in which the swarm moves may for example send obstacle detection information N times more often than a drone analyzing another zone.

The configuration adopted by the swarm may also evolve as a function of the movement speed V of the swarm. For example, when it is high, it will be necessary to have precise knowledge of the environment toward which the swarm is moving. Likewise, in case of attack, the swarm becomes immobilized and the drones are oriented so as to observe the environment in all directions to be able to detect the threat.

The swarm described above is discreet in that it does not require any ground-swarm communication to carry out the detection and avoidance functionality. It is discreet because the number of communication links is optimized. It manages the detection and obstacle avoidance functionality autonomously. It is made up of light drones with on-board sensor systems at a low cost.

1. A swarm made up of a plurality of drones, a drone of the swarm being a flying drone, the drones of the swarm forming a communication network with one another, wherein the swarm implements, in autonomy, an obstacle avoidance functionality based on a collaborative observation of an environment of the swarm by each drone of the swarm and a sharing of obstacle detection information among the drones of the swarm.

2. The swarm according to claim 1, wherein each drone has:
a sensor system for observing an environment of the swarm within a partial observation envelope and generating obstacle detection information in case an obstacle is present within said partial observation envelope;
a radio communication means for establishing at least one communication link with another drone of the swarm to exchange obstacle detection information; and
a computing unit for computing an individual trajectory of the drone from obstacle detection information generated by said drone or received from another drone of the swarm.

3. The swarm according to claim 2, wherein the computing unit of each drone of the swarm determines a relative position and/or a relative speed of at least one drone close to said drone, the computing unit of said drone computing the individual trajectory of said drone while further taking into account said relative position and/or said relative speed.

4. The swarm according to claim 2, wherein the computing unit of each drone of the swarm computes the individual trajectory of said drone such that the swarm adopts an optimized configuration.

5. The swarm according to claim 4, wherein the optimized configuration is optimized by maximizing a zone of the environment observed by the swarm, the zone corresponding to the union of the partial observation envelopes of the drones of the swarm.

6. The swarm according to claim 5, wherein, the swarm moving along a main direction, the drones of the swarm are oriented so that the zone is preferably located in front of the swarm.

7. The swarm according to claim 4, wherein the optimized configuration is optimized such that a topology of the communication network formed by the drones of the swarm is connected, preferably bi-connected.

8. The swarm according to claim 4, wherein the swarm moves away from its optimized configuration by deformation to avoid an obstacle, and then resumes the optimized configuration after having passed the obstacle.

9. The swarm according to claim 4, wherein the optimized configuration is optimized such that a distance between two drones close one from the other is constrained around a reference distance.

10. The swarm according to claim 2, wherein the drones of the swarm are identical to one another, the sensor systems taken on board by each drone of the swarm being identical.

11. The swarm according to claim 2, wherein the drones of the swarm are different, the sensor systems taken on board by each drone of the swarm being identical or different, the swarm being heterogeneous.

12. The swarm according to claim 1, wherein each drone of the swarm is a light drone, having a total span of less than a meter.

13. The swarm according to claim 2, wherein the computing unit of a drone of the swarm stores a matrix meshing the environment of the swarm, the matrix being subdivided into cells, each cell in which an obstacle has been detected being associated with a flag, an update of the matrix being done from obstacle detection information generated by said drone or received by said drone from another drone of the swarm.

14. The swarm according to claim 13, wherein a dimension of the cells of the matrix depends on the partial observation envelopes of the sensor systems of the drones of the swarm.

15. A detection and obstacle avoidance method carried out in a swarm according to claim 1, comprising the following steps:
adoption of an optimized configuration by the swarm;
observation of a zone of the environment corresponding to the union of the partial observation envelopes of the drones of the swarm;
sharing obstacle detection information generated by a drone with the other drones of the swarm using the communication network established among the drones of the swarm; and
calculation by each drone of an individual trajectory, taking account of the obstacle detection information that said drone has generated and/or that said drone has received from other drones.
